(19) United States
(12) Patent Application Publication
(10) Pub. No.: US 2012/0257348 A1
(43) Pub. Date: Oct. 11, 2012

(54) DATA CENTER AND HEAT DISSIPATING SYSTEM THEREOF

(75) Inventor: JO-YU CHANG, Tu-Cheng (TW)

(73) Assignee: HON HAI PRECISION INDUSTRY CO., LTD., Tu-Cheng (TW)

(21) Appl. No.: 13/095,903

(22) Filed: Apr. 28, 2011

(30) Foreign Application Priority Data
Apr. 7, 2011 (TW) 100111978

(51) Int. Cl. G06F 1/20

(52) U.S. Cl. 361/679.48

(57) ABSTRACT

A data center includes a container, a number of server systems and a number of heat dissipating systems. The server systems and the heat dissipating system are received in the container. Each of the server systems includes a number of servers. Each of the servers includes at least one temperature sensor. Each of the heat dissipating systems is configured for cooling a corresponding one of the server systems, and includes a number of fans corresponding to the servers, and a fan control module. The fan control module is configured for acquiring temperature values of the servers from the temperature sensors, and transforming the temperature values into fan speed signals to control the speed of the fans.

### BACKGROUND

1. Technical Field

The present disclosure relates to data centers and, particularly, to a container data center system with a heat dissipation system.

2. Description of Related Art

Each data center includes a plurality of servers, the servers emits heat when working. A heat dissipating system is employed for cooling the servers. Yet, some servers may have higher temperatures than others when working. Thus, different servers may need different cooling levels, so the conventional heat dissipating system cannot fulfill this need.

Therefore, it is desirable to provide a heat dissipating system, which can overcome the limitations described.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the present disclosure. Moreover, in the drawings, like reference numerals designate corresponding parts throughout the several views, and all the views are schematic.

FIG. 1 is a schematic, isometric view of a data center according to an embodiment of the present disclosure.

FIG. 2 is an enlarged, partial internal view of the data center of FIG. 1.

FIG. 3 is a block diagram of a heat dissipating system of the data center of FIG. 1.

FIG. 4 is a fan control table which is used in the heat dissipating system of FIG. 3.

### DETAILED DESCRIPTION

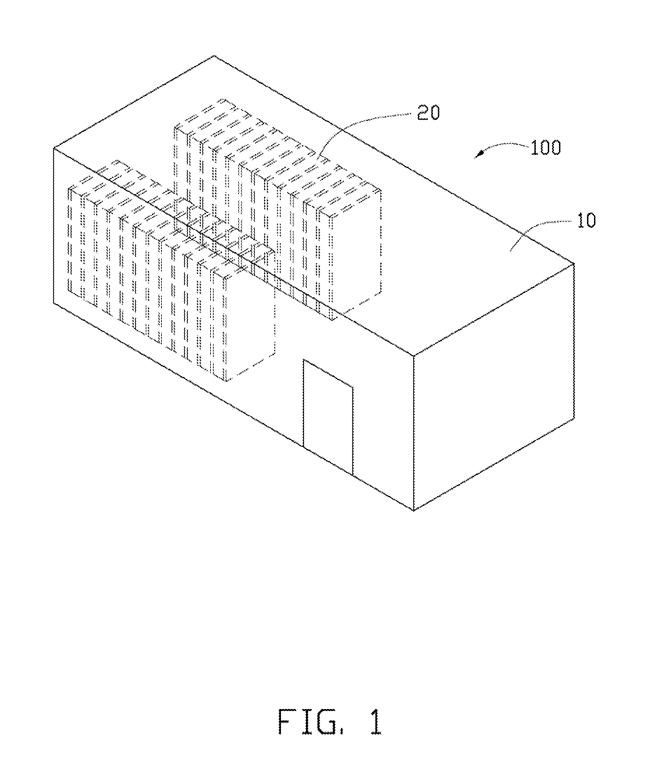

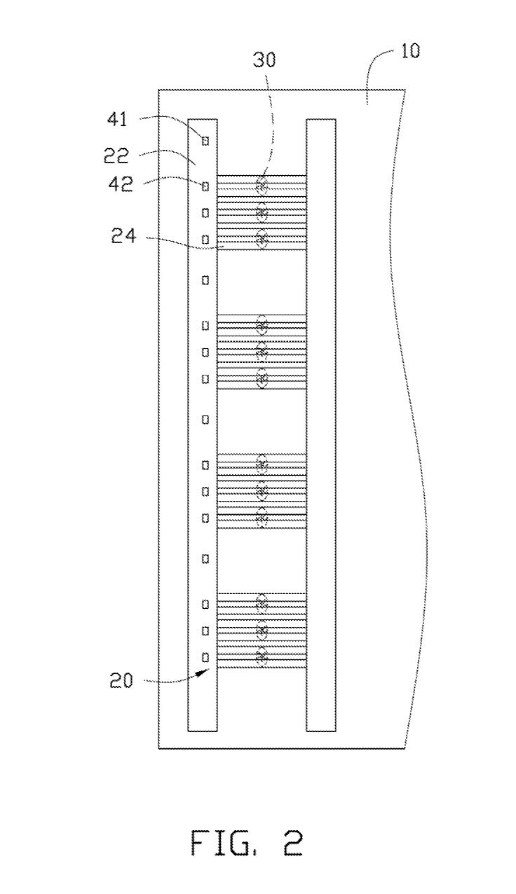

Referring to FIGS. 1 and 2, a data center 100 according to an embodiment is shown. The data center 100 includes a container 10, a plurality of racks 22 received in the container 10, and a plurality of server systems 20 mounted on the racks 22. In this embodiment, each four server systems 20 are mounted in one of the racks 22 and each server systems 20 includes a plurality of servers 24.

The data center 100 further includes a plurality of heat dissipating systems, each of the dissipating systems is configured for cooling one of the server systems 20.

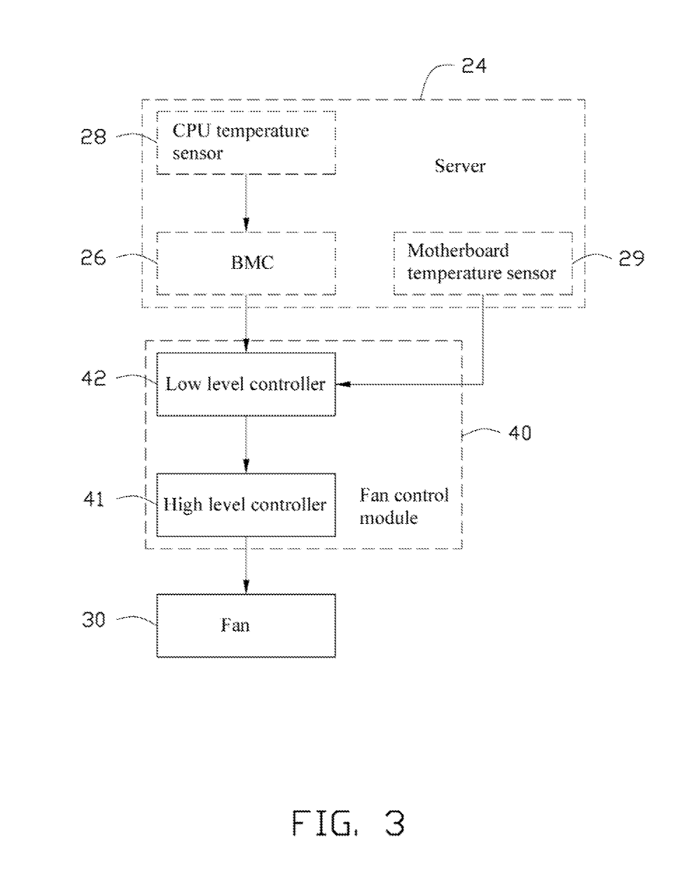

Referring also to FIG. 3, each server 24 includes a baseboard management controller (BMC) 26, a CPU temperature sensor 28 connected to the BMC 26, and a motherboard temperature sensor 29.

Each heating dissipating system includes a plurality of fans 30 and a fan control module 40. The number of the fans 30 is less than that of the corresponding servers 24. In this embodiment, the fans 30 are mounted on the walls of the container 10 adjacent to the servers 24. Each fan 30 is configured for cooling two adjacent servers 24.

The fan control module 40 includes a high level controller 41 and a plurality of low level controllers 42 both mounted on the racks 22. Each low level controller 42 corresponds to one or more servers 24. The low level controller 42 is positioned adjacent to the corresponding servers 24 and is connected with the BMCS 26 and the motherboard temperature sensors 29 of the corresponding servers 24. The high level controller 41 is adjacent to the corresponding server system 20 and is connected with the low level controllers 42.

The CPU temperature sensors 28 measures the CPU temperatures of the servers 24 and sends out the CPU temperature values to the low level controllers 42 via the BMCS 26. The motherboard temperature sensors 29 measures the motherboard temperatures of the servers 24 and send out the motherboard temperature values to the low level controllers 42. The low level controllers 42 sends out the CPU temperature values and the motherboard temperature values to the high level controller 41.

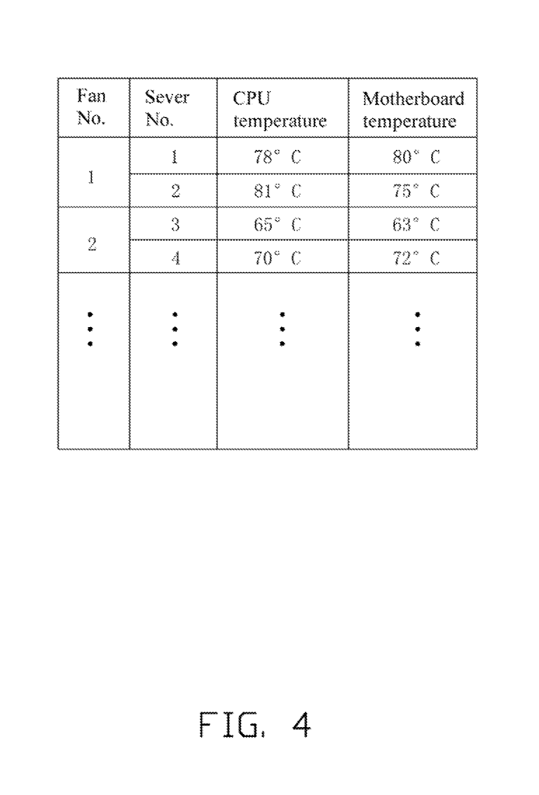

The high level controller 41 adjusts the speeds of the fans 30 according to the CPU temperature values and the motherboard temperature values of the corresponding servers 24. Referring to FIG. 4, in detail, the high level controller 41 stores a fan control table. The fan control table includes a column for listing the fans 30, a column for listing the corresponding servers 24, a column for listing the CPU temperature values of the servers 24, and a column for listing the motherboard temperature values of the servers 24. When receiving a CPU temperature value or a motherboard temperature value, the high level controller 41 sets the temperature value in the corresponding field of the fan control table. Determines which fan 30 corresponds to the temperature value, searches the fan control table to find a highest temperature value corresponding to the fan 30, transforms the highest temperature value to a fan speed signal, and adjusts the speed of the corresponding fan 30 according to the fan speed signal. In this way, the speeds of the fans 30 are adjusted according to the temperatures of the corresponding servers 24, and a flexible and power saving heat dissipating system is acquired.

It will be understood that the above particular embodiments are shown and described by way of illustration only. The principles and the features of the present disclosure may be employed in various and numerous embodiments thereof without departing from the scope of the disclosure. The above-described embodiments illustrate the scope of the disclosure but do not restrict the scope of the disclosure.

What is claimed is:

1. A data center comprising:
a container;
a plurality of server systems received in the container, wherein each of the server systems comprises a plurality of servers, and each of the servers comprises at least one temperature sensor; and
a plurality of heat dissipating systems received in the container, each of the heat dissipating systems being configured for cooling a corresponding one of the server systems and comprising:
a plurality of fans corresponding to the servers of the corresponding server systems; and
a fan control module electrically connected to the fans and configured for acquiring temperature values of the servers of the corresponding server systems from the temperature sensors, and transforming the temperature values into fan speed signals to control the speed of the fans.

2. The data center of claim 1, further comprising a plurality of racks, the server systems being mounted on the racks.

3. The data center of claim 1, wherein each of the at least one temperature sensor comprises a CPU temperature sensor and a motherboard temperature sensor.

4. The data center of claim 3, wherein each of the servers further comprises a baseboard management controller (BMC), the BMC is configured for receiving a CPU temperature value from the CPU temperature sensor.

5. The data center of claim 1, wherein each fan is configured for cooling two adjacent servers, the fan control module is configured for selecting a highest temperature value from the temperature values of each two adjacent servers, and transforming the highest temperature value into a fan speed signal to control the speed of a corresponding fan.

6. The data center of claim 1, wherein the fan control module comprises a plurality of low level controllers and a high level controller, each of the low level controllers is configured for acquiring the temperature values of at least one of the servers and sending the temperature values to the high level controller, and the high level controller is configured for transforming the temperature values into the fan speed signals to control the speed of the fans.

7. A heat dissipating system for cooling a server system, the server system comprising a plurality of servers, and each of the servers comprising at least one temperature sensor, the heat dissipating systems comprising:
a plurality of fans for cooling the servers; and
a fan control module electrically connected to the fans and configured for acquiring temperature values of the servers from the temperature sensors, and transforming the temperature values into fan speed signals to control the speed of the fans.

8. The heat dissipating system of claim 7, wherein each fan is configured for cooling two adjacent servers, the fan control module is configured for selecting a highest temperature value from the temperature values of each two adjacent servers, and transforming the highest temperature value into a fan speed signal to control the speed of a corresponding fan.

9. The heat dissipating system of claim 7, wherein the fan control module comprises a plurality of low level controllers and a high level controller, each of the low level controllers is configured for acquiring the temperature values of at least one of the servers and sending the temperature values to the high level controller, and the high level controller is configured for transforming the temperature values into the fan speed signals to control the speed of the fans.
